(19) United States
(12) Patent Application Publication
(10) Pub. No.: US 2025/0274800 A1
(43) Pub. Date: Aug. 28, 2025

(54) QOS SPECIFIC BEAM PREDICTION

(71) Applicant: QUALCOMM Incorporated, San Diego, CA (US)

(72) Inventors: Tianyang BAI, Mountain View, CA (US); Hua WANG, Basking Ridge, NJ (US); Mahmoud TAHERZADEH BOROUJENI, San Diego, CA (US); Qiaoyu LI, Beijing (CN); Hamed PEZESHKI, San Diego, CA (US); Arumugam CHENDAMARAI KANNAN, San Diego, CA (US); Taesang YOO, San Diego, CA (US); Tao LUO, San Diego, CA (US); Junyi LI, Greentown, PA (US)

(21) Appl. No.: 18/874,578

(22) PCT Filed: Aug. 9, 2022
(86) PCT No.: PCT/CN2022/111108

§ 371 Date: Dec. 12, 2024

(51) Int. Cl. H04W 24/10

(52) U.S. Cl. CPC H04W 24/10

(57) ABSTRACT

Certain aspects relate to quality of service (QoS) based beam prediction. For example, an apparatus may obtain, from a network entity, a set of machine learning module configurations associated with a set of quality of service (QoS) types. The apparatus may identify a QoS type, from the set of QoS types, for data scheduled to be communicated with the network entity. The apparatus may select a machine learning module configuration from the set of machine learning module configurations based on the QoS type. The apparatus may output, for transmission to the network entity, a report associated with the one or more beam prediction procedures.

### BACKGROUND

### Technical Field

The present disclosure generally relates to communication systems, and more particularly, to Quality of Service (QoS) specific beam prediction.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

There exists a need for further improvements in 5G NR technology. These improvements may also be applicable to other multi-access technologies and the telecommunication standards that employ these technologies. For instance, improvements to efficiency and latency relating to mobility of user equipments (UEs) communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a method for wireless communication at a user equipment. In some examples, the method includes obtaining, from a network entity, a set of machine learning module configurations associated with a set of quality of service (QoS) types. In some examples, the method includes identifying a QoS type, from the set of QoS types, for data scheduled to be communicated with the network entity. In some examples, the method includes selecting a machine learning module configuration from the set of machine learning module configurations based on the QoS type. In some examples, the method includes performing one or more beam prediction procedures based on an output of a machine learning model indicated by the selected machine learning module configuration. In some examples, the method includes outputting, for transmission to the network entity, a report associated with the one or more beam prediction procedures.

Certain aspects are directed to a method for wireless communication at a network entity. In some examples, the method includes outputting, for transmission to a user equipment (UE), a set of machine learning module configurations associated with a set of quality of service (QoS) types. In some examples, the method includes obtaining, from the UE, a report being based on a machine learning module configuration from the set of machine learning module configurations.

Certain aspects are directed to an apparatus configured for wireless communication, comprising a memory comprising instructions and one or more processors configured to execute the instructions. In some examples, the apparatus is configured to obtain, from a network entity, a set of machine learning module configurations associated with a set of quality of service (QoS) types. In some examples, the apparatus is configured to identify a QoS type, from the set of QoS types, for data scheduled to be communicated with the network entity. In some examples, the apparatus is configured to select a machine learning module configuration from the set of machine learning module configurations based on the QoS type. In some examples, the apparatus is configured to perform one or more beam prediction procedures based on an output of a machine learning model indicated by the selected machine learning module configuration. In some examples, the apparatus is configured to output, for transmission to the network entity, a report associated with the one or more beam prediction procedures.

Certain aspects are directed to an apparatus configured for wireless communication, comprising a memory comprising instructions and one or more processors configured to execute the instructions. In some examples, the apparatus is configured to output,, for transmission to a user equipment (UE), a set of machine learning module configurations associated with a set of quality of service (QoS) types. In some examples, the apparatus is configured to obtain, from the UE, a report being based on a machine learning module configuration from the set of machine learning module configurations.

Certain aspects are directed to a non-transitory computer-readable medium having instructions stored thereon that, when executed by an apparatus, cause the apparatus to perform operations comprising obtaining, from a network entity, a set of machine learning module configurations associated with a set of quality of service (QoS) types. In some examples, the operations include identifying a QoS type, from the set of QoS types, for data scheduled to be communicated with the network entity. In some examples, the operations include performing one or more beam prediction procedures based on an output of a machine learning model indicated by the selected machine learning module configuration. In some examples, the operations include outputting, for transmission to the network entity, a report associated with the one or more beam prediction procedures.

Certain aspects are directed to a non-transitory computer-readable medium having instructions stored thereon that, when executed by an apparatus, cause the apparatus to perform operations comprising outputting, for transmission to a user equipment (UE), a set of machine learning module configurations associated with a set of quality of service (QoS) types. In some examples, the operations include obtaining, from the UE, a report being based on a machine learning module configuration from the set of machine learning module configurations.

Certain aspects are directed to an apparatus for wireless communication. In some examples, the apparatus includes means for obtaining, from a network entity, a set of machine learning module configurations associated with a set of quality of service (QoS) types. In some examples, the apparatus includes means for identifying a QoS type, from the set of QoS types, for data scheduled to be communicated with the network entity. In some examples, the apparatus includes means for selecting a machine learning module configuration from the set of machine learning module configurations based on the QoS type. In some examples, the apparatus includes means for performing one or more beam prediction procedures based on an output of a machine learning model indicated by the selected machine learning module configuration. In some examples, the apparatus includes means for outputting, for transmission to the network entity, a report associated with the one or more beam prediction procedures.

Certain aspects are directed to an apparatus for wireless communication. In some examples, the apparatus includes means for outputting, for transmission to a user equipment (UE), a set of machine learning module configurations associated with a set of quality of service (QoS) types. In some examples, the apparatus includes means for obtaining, from the UE, a report being based on a machine learning module configuration from the set of machine learning module configurations.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating an machine learning model, in accordance with various aspects of the present disclosure.

FIG. 5 is a call flow diagram illustrating an example communications, in accordance with various aspects of the present disclosure.

FIG. 6 is a diagram illustrating an example of a hardware implementation for an example apparatus.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating another example of a hardware implementation for another example apparatus.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Existing techniques for beam management and beam prediction can result in significant overhead and can consume significant amount of power. For example, existing techniques for beam predictions may require frequent transmission of reference signals from a network entity to a user equipment (UE) so that the UE can track beam and/or channel conditions and report them back to the network entity. However, such frequent reception of reference signals and tracking beam and/or channel conditions can result in significant overhead for the UEs. Additionally, existing techniques for beam management and beam prediction may require frequent channel estimation feedback from the UE to the network entity. Such frequent feedback can result in consuming significant number of resources for the UE and can further increase the overhead for beam prediction and/or beam management by the UE. Furthermore, the frequent measurement of reference signals and estimation of channel metrics may consume significant power of the UE. Additionally, in non-line-of-sight (NLOS) regions and/or with multipath signaling can result in random fading of signals which can increases the difficultly in accurately predicting the best beams.

Accordingly, the techniques described herein reduce the overhead and power consumption for the UE for beam management and/or beam prediction and improves accuracy of a beam prediction. In certain aspects, UE may identify and/or determine a quality of service (QoS) type for data scheduled to be communicated with a network entity. The UE may perform one or more beam prediction procedures based on an output of machine learning model associated with the QoS type. The UE may output a report associated with one or more beam prediction procedures for transmission to the network entity. The report may indicate a set of predicted channel metrics for a set of beams and/or a set of confidence levels associated with the set of predicted channel metrics. Additional details of these techniques are described below.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

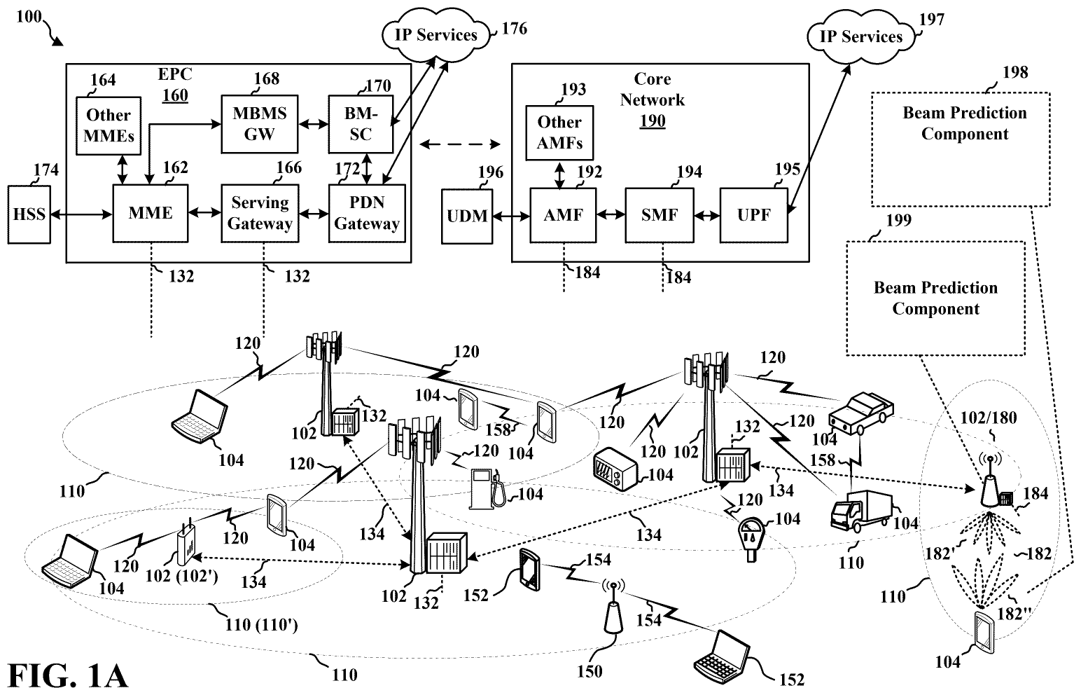

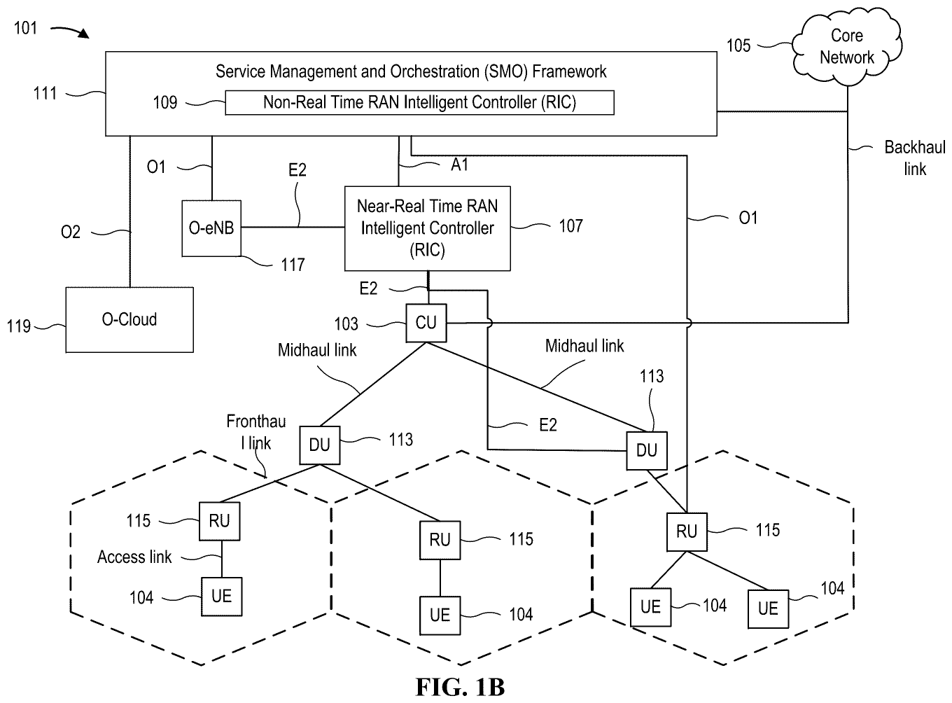

FIG. 1 is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

One or more of the UE 104 may include beam prediction component 198, and one or more of the base stations 102/180 may be configured to include a beam prediction component 199, wherein the beam prediction component 198 and beam prediction component 199 are operable to perform techniques for beam prediction while reducing overhead and power consumption for UE and improving the accuracy of beam prediction.

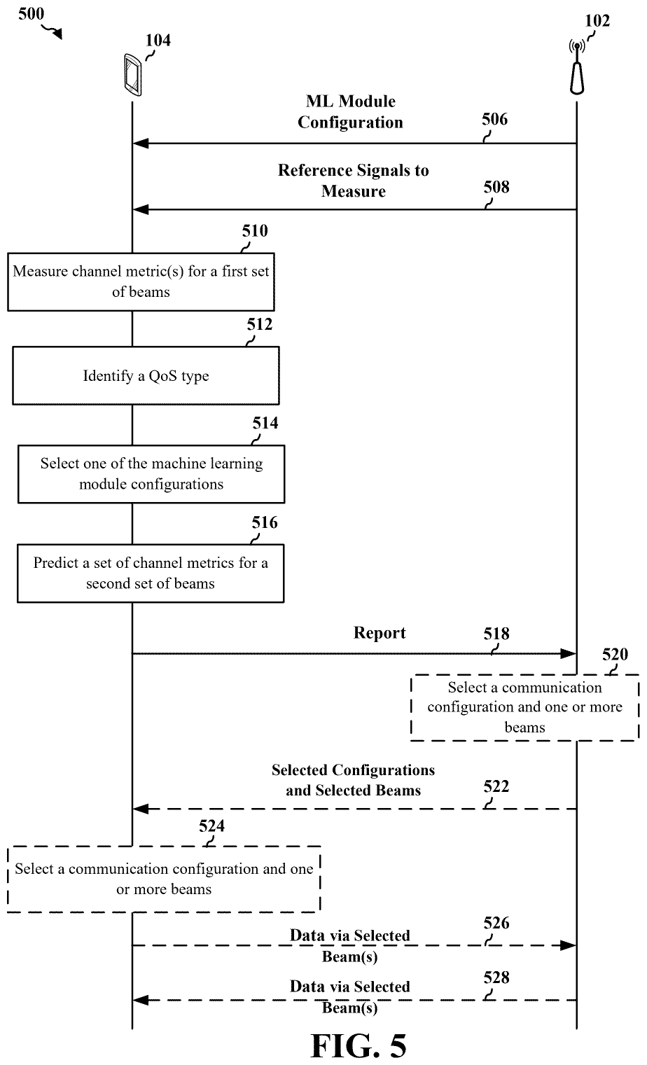

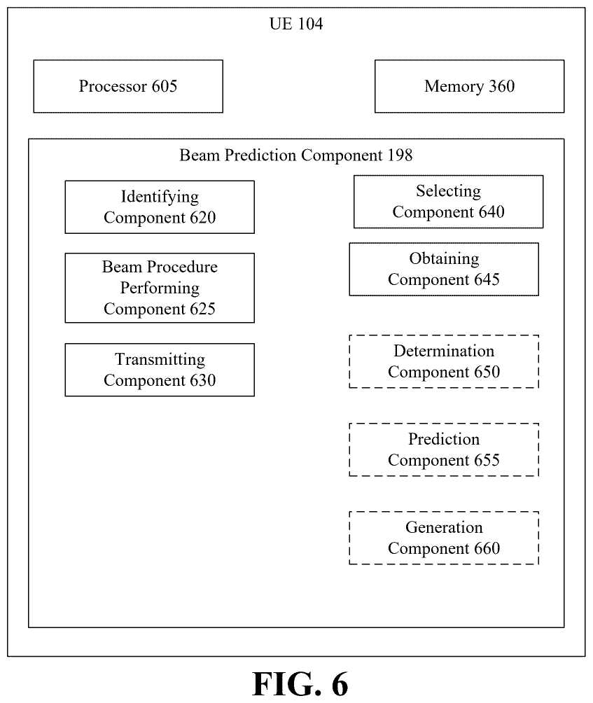

At one or more of the UEs 104, and additionally referring to FIG. 6, the beam prediction component 198 includes an obtaining component 645 configured to obtain, from a network entity, a set of machine learning module configurations associated with a set of quality of service (QoS) types. Further, the beam prediction component 198 includes an identifying component 620 configured to identify a QoS type, from the set of QoS types, for data scheduled to be communicated with the network entity. Further, the beam prediction component 198 includes a selecting component 640, select a machine learning module configuration from the set of machine learning module configurations based on the QoS type. Further, the beam prediction component 198 includes a beam procedure performing component 625 configured to perform one or more beam prediction procedures based on an output of a machine learning model indicated by the selected machine learning module configuration. Additionally, the beam prediction component 198 includes a transmitting component 630 configured to output, for transmission to the network entity, a report associated with the one or more beam prediction procedures. Also, in some optional or additional aspects, the beam prediction component 198 may include a selecting component 640, obtaining component 645, determination component 650, and prediction component 655. Additional details of the identifying component 620, beam procedure performing component 624, transmitting component 630, selecting component 640, obtaining component 645, determination component 650, prediction component 655 are provided below, for example, with reference to FIGS. 5-12.

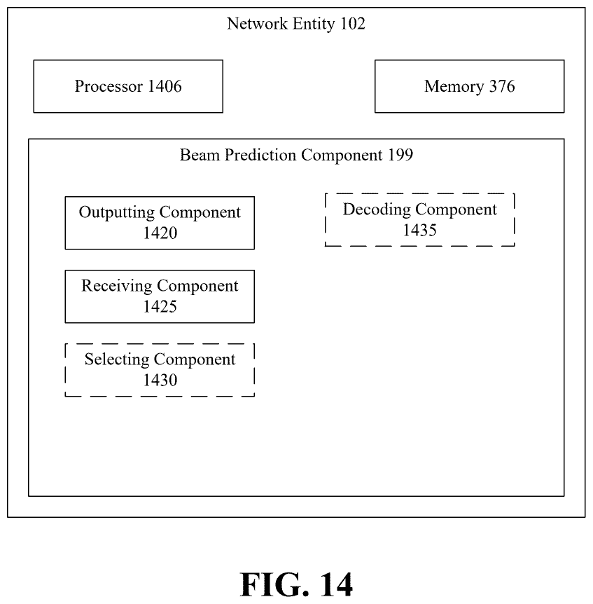

At one or more of the base stations 102/180 (or, network entities), and additionally referring to FIG. 14, the beam prediction component 199 includes an outputting component 1420 configured to output, for transmission to a user equipment (UE), a set of machine learning module configurations associated with a set of quality of service (QoS) types. Additionally, the beam prediction component 199 includes a receiving component 1425 configured to obtain, from the UE, a report associated with one or more beam prediction procedures performed by the UE based on an output of a machine learning model indicated by a machine learning module configuration from the set of machine learning module configurations. Also, in some optional or additional aspects, the beam prediction component 199 may include a selecting component 1430, decoding component 1435. Additional details of the outputting component 1420, receiving component 1425, selecting component 1430, decoding component 1435 are provided below, for example, with reference to FIGS. 5, 14-20.

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUS may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FRI and FR2 are often referred to as mid-band frequencies. Although a portion of FRI is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), cFeMTC (enhanced further cMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUS 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit—Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-CNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

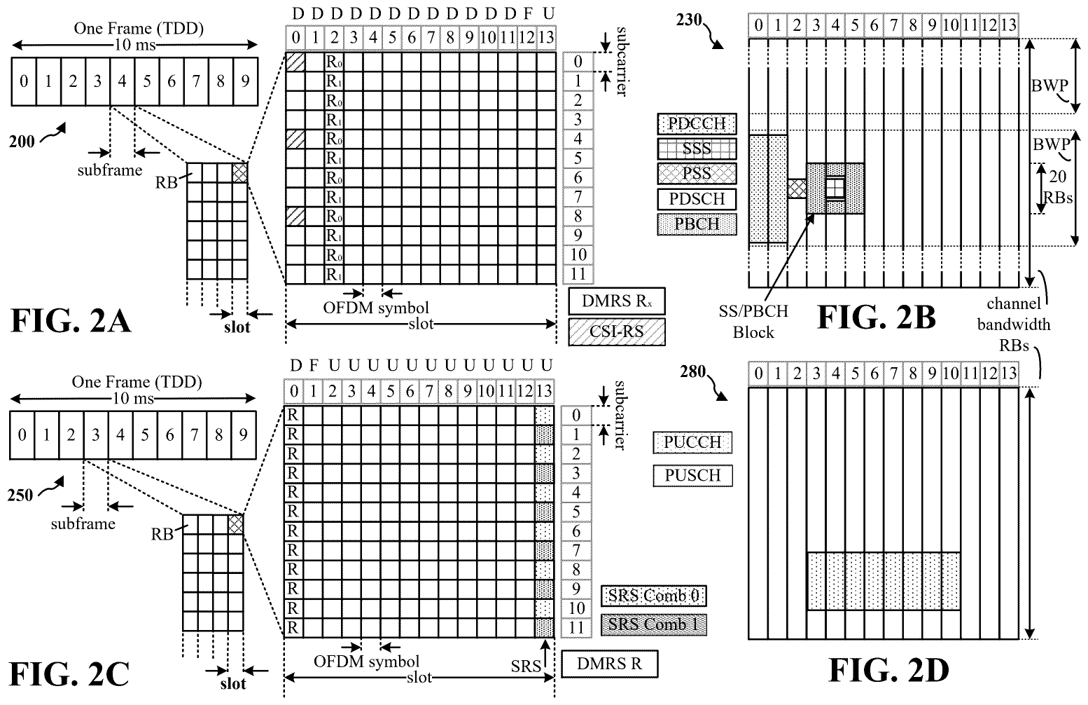

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}* 15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

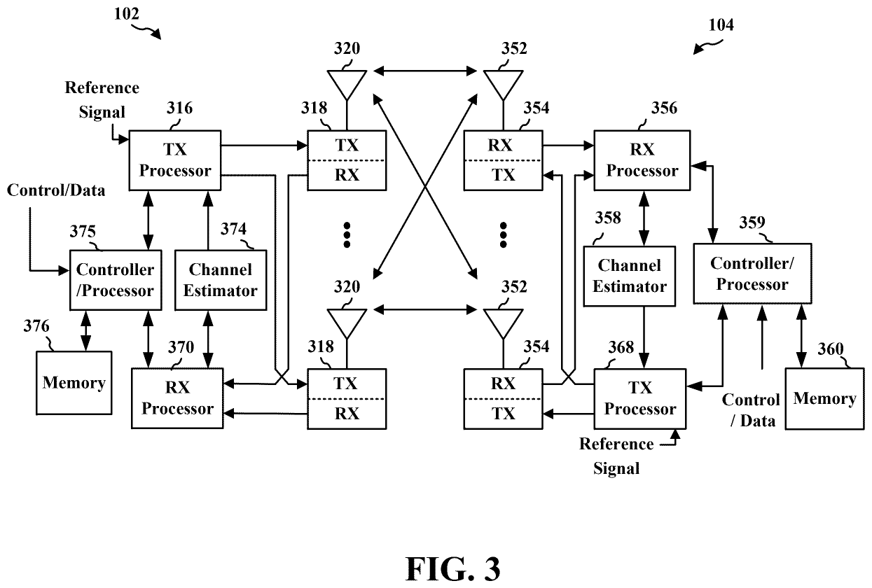

FIG. 3 is a block diagram of hardware components of the base station 102 (or 180) in communication with the UE 104 in the wireless communication network 100. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are then decoded and deinterleaved to recover the data and control signals that were originally transmitted by the base station 102 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. For example, the memory 360 may include executable instructions defining the beam prediction component 198. The TX processor 368, the RX processor 356, and/or the controller/processor 359 may be configured to execute the beam prediction component 198.

At least one of the TX processor 316, the RX processor 370, and the controller/processor 375 may be configured to perform aspects in connection with 199 of FIG. 1. For example, the memory 376 may include executable instructions defining the beam prediction component 199. The TX processor 316, the RX processor 370, and/or the controller/processor 375 may be configured to execute the beam prediction component 199.

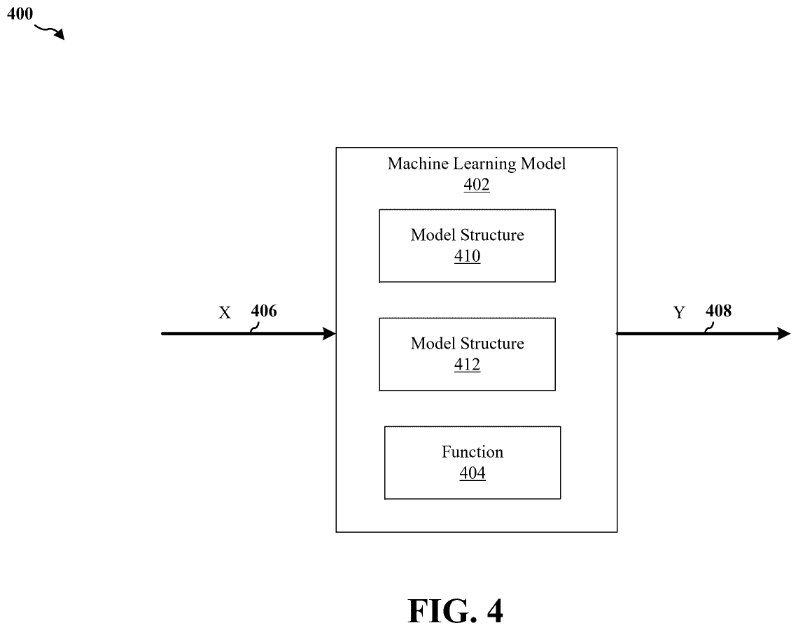

Referring to FIG. 4, UE 104 and/or a network entity, such as base station 102/180, or a component of an D-RAN or O-RAN architecture, may be configured or preconfigured with one or more machine learning models 402. Examples of such machine learning models may include, but are not limited to, neural network (NN) models. Each machine learning model may support a function 404 (e.g., a neural network function (NNF), and the like). The function 404 (e.g., NNF, and the like), may be associated with a standardized identifier (e.g., an NNF identifier) to enable different entities, such as network operators, infrastructure vendors, equipment manufacturers and the like, to support, access, and/or integrate the function. In some implementations, the function 404 may be associated with a non-standardized identifiers or entity specific identifiers. The function 404 may be supported by multiple machine learning models 402, which may allow for different entities to access, integrate and/or support the function 404 with entity (e.g., network operators, infrastructure vendors, equipment manufacturers and the like) specific implementation.

The machine learning model 402 may be configured to receive standardized inputs 406 and output a standardized output 408. In some implementations, the inputs 406 and output 408 may be standardized to allow for inter-entity (e.g., inter-vendor, inter-network operator, inter-manufacturer) interworking/interoperability and the like. The machine learning model 402 may be defined by one or more model structures 410 and one or more parameter sets 412. The model structure(s) 410 and the parameter sets 412 may be defined by the entities (e.g. network operators, infrastructure vendors, equipment manufacturers and the like).

In some implementations, each model structure 410 may define one or more layers (e.g., neural network layers) of the machine learning model 402. Each model structure 402 may be associated with a unique model identifier (model ID), and each model ID may be associated with a function 404 (e.g., a neural network function). Each parameter set 412 may include weights and other configuration parameters for the machine learning model 402, and each parameter set may associated with a unique identifier. In some implementations, each model structure 410 may be configured with and/or function based a default parameter set. In some implementations, different parameter sets 412 may be configured for different locations. In some implementations, different parameter sets 412 may be used with the machine learning model 402 based on the location of the UE 104 or the network entity (e.g., base station 102/180).

The machine learning models 402 may be trained to predict future channel metrics for a first set of beams based on measurements of channel metrics for a second set of beams. For example, the UE 104 may measure a set of channel metrics for the second set of beams at time k+1−n. The set of channel metrics measured at time k+1−n may be provided as input 406 to the machine learning model 402 and the machine learning model 402 may output 408 a set of predicted future (e.g., time k+1) channel metrics for a second set of beams. In some implementations, the first set of beams and the second set of beams may be same, or overlap each other, or different from each other. For example, the second set of beams may be a subset of SSB and the first set of beams may be all of the SSBs. Similarly, the second set of beams may be SSBs and the first set of beams may be CSI-RS beams or refined CSI-RS beams for unicast in PDSCH or PDCCH.

In some implementations, the output 408 of the machine learning models 402 may include a beam identifier associated with each of the predicted channel metrics and/or other statistical measurements (e.g., confidence levels, probability of accuracy, and the like) associated with the predicted channel metrics. In some implementations, the machine learning models 402 may trained remotely to the UE 104. For example, the machine learning models 402 may be trained at a network entity (e.g., base station 102/180). UE 104 may be configured with the different machine learning models 402 and the different model structures 410 and different parameters sets 412.

Referring now to FIG. 5, a call-flow diagram illustrating example communications 500 between a UE 104 and a network entity 102/180 (e.g., base station 102/180, a component of an D-RAN or O-RAN architecture, and the like) are shown. At communication 506, the network entity 102/180 may transmit one or more machine learning module configurations to the UE 104. Different machine learning module configurations may correspond to or be associated with different machine learning models 402, model structures 410 and/or parameter sets 412. Each of the different machine learning module configurations may indicate a machine learning model 402 for different quality of service (QoS) types. In some implementations, different machine learning models 402 may be associated with different QoS types. Each QoS type may be associated with a different traffic type and/or a set of QoS requirements. Examples of traffic types may include but are not limited to enhanced Mobile Broadband (cMBB) traffic, Ultra Reliable Low Latency Communications (URLLC) traffic, massive machine-type communications (mMMTC) traffic, and the like. QoS requirements for data service or traffic may be specified and/or indicated in terms of data rate, latency and/or reliability. For example, some sets of QoS requirements associated with some data traffic may specify that an end-to-end latency of less than 15 milliseconds and a reliability requirement of greater than 99.9999%. Similarly other sets of QoS requirements associated with other data traffic may specify peak data rates of greater than 1 gigibits per second (Gbps), latency of less than 20 milliseconds, and reliability of greater than 99.99%. In some implementations, each of the one or more machine learning module configurations may indicate a model structure identifier of a model structure (e.g., model structure 410) and/or parameter set identifier of a parameter set (e.g., parameter set 412).

At communication 508, the network entity 102/180 may transmit a set of reference signals (e.g., DMRS, PTRS, SRS, CSI-RS, and the like) to UE 104 for measuring channel metrics of a first set of beams. At process 510, UE 104 may measure one or more channel metrics for a first set of beams (e.g., a subset of SSB beams) based on the received reference signals from network entity 102/180. The channel metrics may be associated with a reference signal received power (RSRP), a reference signal received quality (RSRQ), a sounding reference signal (SRS), a received signal strength indicator (RSSI), or a signal-to-noise and interference (SINR) ratio.

At process 512, UE 104 may identify a QoS type. UE 104 may identify the QoS type for data scheduled to be communicated with a network entity based on a set of defined rules or a QoS related indication from the network entity 102/180. UE 104 may be configured with the defined rules. The defined rules can be predefined or predetermined. In some implementations, the defined rules may be dynamically defined. For example, UE 104 may receive, from network entity 102/180, one or more rule configurations associated with identifying QoS types for data scheduled to be communicated with the network entity 102/180. UE 104 may receive a scheduling grant for the data to be communicated with the network entity 102/180. In some implementations, the scheduling grant may indicate a traffic type or priority level for the scheduled data, and the UE 104 may be configured to identify or determine QoS type based on the indicated priority. For example, the scheduling grant may indicate a physical layer (PHY) priority associated with the HARQ of a downlink assignment, and the UE 104 may be configured to identify or determine that the QoS type associated with the scheduled data is high priority if the indicated PHY priority is 1 and of a regular or a default priority if the indicated PHY priority is 0. UE 104 may similarly determine a QoS type for scheduled data based on an uplink assignment.

In some implementations, UE 104 may be configured to identify or determine QoS type based on a set of defined rules and/or the scheduling grant. An example of a set of defined rules may associate a first set of HARQ process identifiers with a first Qos type, traffic type, or QoS requirements, a second set of HARQ process identifiers with a second QoS type, traffic type, or QoS requirements, and so on. For example, UE 104 may be preconfigured with a set of rules that specify or indicate that a HARQ process identifiers 1 to K are associated with traffic with default priority, regular data traffic, or cMBB traffic and that HARQ process identifiers K+1 is associated with high priority data traffic, or URLLC traffic. Then, based on the preconfigured rules, the UE 104 may determine that the scheduled data is default or regular priority data and identify a corresponding QoS type if the scheduling grant indicated a HARQ process ID of K. Similarly, the UE 104 may determine that the scheduled data is high priority data and identify a corresponding QoS type if the scheduling grant indicated a HARQ process ID of K+1.

In some implementations, the network entity may indicate a QoS type of scheduled data in the one or more machine learning module configurations transmitted at process 506. The UE 104 may be configured to identify or determine the QoS type for scheduled data based on the received machine learning module configurations.

At process 514, the UE 104 may select one of the machine learning module configurations received from the network entity 102/180 at process 506 based on the identified QoS type. The UE 104 may apply the model structure or parameter set indicated in the selected machine learning module configuration. At process 516, the UE 104 may predict a set of channel metrics for a second set of beams. UE 104 may predict the set of channel metrics for the second set of beams based on the output of the selected machine learning model. The UE 104 may apply the model structure (e.g., 410) or parameter set (e.g., 412) indicated in the machine learning module configuration to the indicated machine learning model. The UE 104 may provide, as an input to the machine learning model, the set of measured channel metrics of first set of beams (e.g., subset of SSB beams) of process 510. Based on the output of the machine learning model, UE 104 may predict the set channel metrics for a second set of beams. As described above, in some implementations, the second set of beams may be the same as the first set of beams, overlap the first set of beams, or may be different from the first set of beams. For example, in some implementations, the first set of beams may be a subset of SSB beams, and the second set of beams may be all of the SSB beams. Similarly, in some implementations, the first set of beams may be the SSB beams or a subset of SSB beams and the second set of beams may be CSI-RS beams or refined CSI-RS beams, and the like.

As described above, UE 104 may measure the channel metrics of the first set of beams at time k+1−n and the set of predicted channel metrics for the second set of beams are what the channel metrics may be at a future time of k+1.

In some implementations, the output of the machine learning model may be the predicted channel metrics for the second set of beams. In some implementations, as described above, the output of the machine learning models 402 may include a beam identifier associated with each of the predicted channel metrics and/or other statistical measurements (e.g., confidence levels, probability of accuracy, and the like) associated with the predicted channel metrics.

At communication 518, UE 104 may transmit a report (e.g., a beam prediction report, a beam management report, and the like) based on the beam prediction procedures to the network entity 102/180. UE 104, may generate the report based on a report configuration associated with the identified QoS type. In some implementations, different report configurations may be associated with different QoS types. In some implementations, the report configuration may be a set of rules that indicate or specify the content of the report (e.g., which beam to report, which predicted channel metric to report, and the like), resource configurations for the report (e.g., different periodicities at which to transmit the report), priority of the report (e.g., PHY priority of the report), and the like. In some implementations, the content of the report may be The content of the report may be based on the report configuration.

For example, a report configuration associated with a QoS type associated with default or regular priority data/traffic or with eMBB data/traffic, may indicate or specify reporting a beam identifier of a beam with the highest predicted RSRP and/or its corresponding predicted RSRP. Similarly, a report configuration with a QoS type associated with high priority data/traffic or URLLC data/traffic may indicate or specify reporting one or more of the predicted channel metrics and their corresponding statistical measurements (e.g., standard deviations, confidence levels).

In some implementations, the report configurations may indicate or specify that for a beam to be included in the report, one or more of the predicted channel metrics of that beam satisfy a corresponding threshold channel metric value. For example, report configuration associated with high priority QoS type may indicate only beams with predicted RSRP values greater than X dBm can be included in the report. In some implementations, the UE 104 may be configured with a predetermined formula to determine a probability that predicted channel metric value may satisfy a threshold channel metric value, and a report configuration may indicate or specify reporting the probability along with the channel metric for the beams.

At process 520, the network entity 102/180, may optionally select a communication configuration, one or more beams, one or more modulation and coding schemes (MCS), power control, other aspects for communication, and/or the like. The network entity 102/180 may be configured with multiple communication configurations (e.g., transmission (Tx)/reception (Rx) configurations) and may select one of the communication configurations based on the report from the UE, the QoS type associated with the report, PHY priority of the report, PHY priority indicated in the report, and/or the traffic type or the priority of the data scheduled for communication with the UE 104. Different communication configurations may be associated with different traffic types or priorities of data. The network entity 102/180 may be configured with a set of rules that indicate or specify selecting a communication configuration associated with the traffic type or priority of data and one or more beams from the beams indicated in the received report from UE 104. For example, the rules may indicate selection of a first communication configuration and selection of a beam with a highest predicted channel metric (e.g., highest RSRP) indicated in the report received from UE 104 when the priority of the scheduled data is default or regular priority. Similarly, the rules may indicate selection of a second communication configuration and two beams with the two of the highest channel metrics indicated in the report received from UE 104 when the priority of the scheduled data is high priority.

In some implementations, selecting a communication configuration may include and/or comprise selecting one or more beams from the set of beams indicated and/or referenced in the report from the UE 104. In some implementations, selecting a communication configuration may include and/or comprise selecting a MCS, power control, other aspects of communication, and/or the like. The network entity 102/180 may be configured to select the one or more beams, the MCS, the power control, and/or the like based on a set of rules that indicate and/or specify selection based on the QoS type associated with and/or indicated in the report, PHY priority of the report, PHY priority indicated in the report, and/or the traffic type or the priority of the data scheduled for communication with the UE 104.

In some implementations, different communication configurations may indicate or specify selection of different beams from the beams reported in the report from the UE 104 at 516. For example, a communication configuration associated with a default priority or a regular priority may indicate or specify selection of beam with a highest predicted channel metric indicated in the report received from UE 104. Similarly, a communication configuration associated with high priority may indicate or specify selection of two beams with the two of the highest channel metrics indicated in the report received from UE 104 when the priority of the scheduled data is high priority. In some implementations, communication configuration may indicate different transmission or reception schemes involving the selected beams. For example, communication configuration associated with high priority may indicate that using a diversity scheme (e.g., slot aggregation) involving the two beams when transmitting data to the UE 104. At communication 522, the network entity may optionally transmit information related to the selected configurations and the selected beams to the UE 102/180.

At process 524, UE 104 may optionally select a communication configuration, one or more beams, one or more modulation and coding schemes (MCS), power control, other aspects for communication, and/or the like. The UE 104 may autonomously, without any indications from network entity, select, the communication configuration (e.g., transmission (Tx)/reception (Rx) configurations) and one or more beams from the beams reported in the report transmitted to the network entity at 516. The UE 104 may be configured with multiple communication configurations and may select one of the communication configurations based on the report transmitted to the network entity 104 and/or the QoS type associated with the report and/or the scheduled data for communication with the network entity. Different communication configurations may be associated with different traffic types or priorities of data. The UE 104 may be preconfigured with a set of rules that indicate or specify selecting a communication configuration associated with the traffic type or priority of data and one or more beams from the beams indicated in the transmitted report to network entity 102/180. For example, the rules may indicate selection of a first communication configuration and selection of a beam with a highest predicted channel metric (e.g., highest RSRP) indicated in the report transmitted to network entity 102/180 when the priority of the scheduled data is default or regular priority. Similarly, the rules may indicate selection of a second communication configuration and two beams with the two of the highest channel metrics indicated in the report transmitted to network entity 102/180 when the priority of the scheduled data is high priority.

In some implementations, selecting a communication configuration may include and/or comprise selecting one or more beams from the set of beams indicated and/or referenced in the report transmitted to the network entity 102/180. In some implementations, selecting a communication configuration may include and/or comprise selecting a MCS, power control, other aspects of communication, and/or the like. The UE 104 may be configured to select the one or more beams, the MCS, the power control, and/or the like based on a set of rules that indicate and/or specify selection based on the QoS type associated with and/or indicated in the report, PHY priority of the report, PHY priority indicated in the report, and/or the traffic type or the priority of the data scheduled for communication with the UE 104.

In some implementations, communication configuration may indicate different transmission or reception schemes involving the selected beams. For example, communication configuration associated with QoS type indicating high priority may indicate using a diversity scheme (e.g., slot aggregation) involving the two beams when transmitting data to or receiving data from the network entity 102/180. In some implementations, different communication configurations may indicate or specify selection of different beams from the beams reported in the report transmitted to the network entity 102/180 at 516. For example, a communication configuration associated with a default priority or a regular priority may indicate or specify selection of beam with a highest predicted channel metric indicated in the report received from UE 104. Similarly, a communication configuration associated with high priority may indicate or specify selection of two beams with the two of the highest channel metrics indicated in the report received from UE 104 when the priority of the scheduled data is high priority.

In some implementations, the network entity 102/180 may be configured with similar rules for selecting communication configurations and/or one or more beams indicated in the report as the UE 104. Therefore, the network entity 102/180 may select the same communication configuration and the same set of beams based on the report transmitted to the network entity 102/180.

At communication 526, UE 104 may optionally transmit data to the network entity 102/180 via one or more of the selected beams and based on the selected communication configuration, and the network entity 102/180 may receive the data via the one or more of the selected beams. At communication 528, network entity 102/180 may optionally transmit data to the UE 104 via one or more of the selected beams and based on the selected communication configuration, and the UE 104 may receive the data via the one or more of the selected beams. The UE 104 and network entity 102/180 may encode and/or decode data based on configuration parameters (e.g., a codebook, and the like) indicated in the selected communication configuration, a selected MCS, and the like.

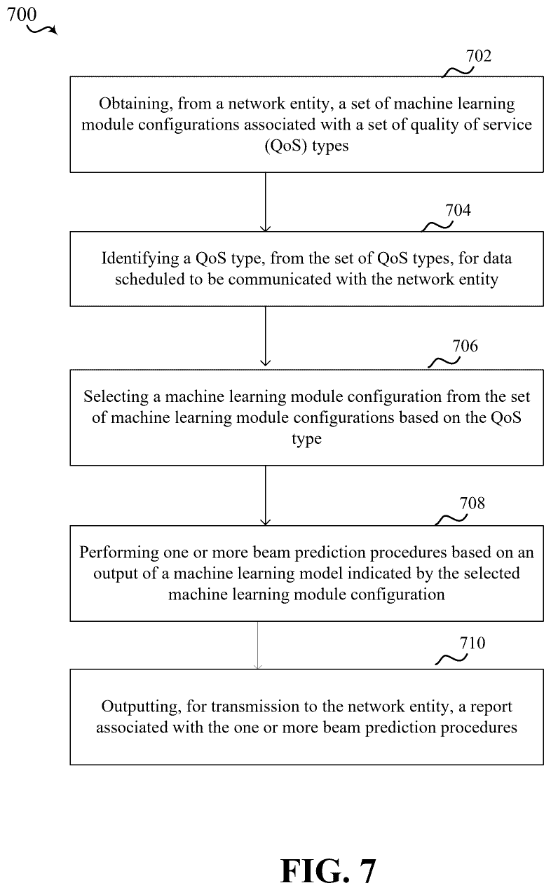

Referring to FIG. 6 and FIG. 7, in operation, UE 104 may perform a method 700 of wireless communication, by such as via execution of beam prediction component 198 by processor 605 and/or memory 360 (FIG. 3). In this case, the processor 605 may be the receive (rx) processor 356, the controller/processor 359, and/or the transmit (tx) processor 368 described above in FIG. 3.

At block 702, the method 700 includes obtaining, from a network entity, a set of machine learning module configurations associated with a set of quality of service (QoS) types. For example, in an aspect, UE 104, means for obtaining, from a network entity, a set of machine learning module configurations associated with a set of quality of service (QoS) types may be configured as or may comprise at least one of UE 104, processor 605, memory 360, beam prediction component 198, and/or obtaining component 645.

For example, the obtaining at block 702 may include receiving the set of machine learning module configurations via a wireless signal at an antenna or antenna array (e.g., antenna 352) as described in FIG. 3.

At block 704, the method 700 includes identifying a quality of service (QoS) type, from the sets of QoS types, for data scheduled to be communicated with the network entity. For example, in an aspect, means for identifying a quality of service (Qos) type for data scheduled to be communicated with a network entity may be configured as or may comprise at least one of UE 104, processor 605, memory 360, beam prediction component 198, and/or identifying component 620.

At block 706, the method 700 includes selecting a machine learning module configuration from the set of machine learning module configurations based on the QoS type. For example, in an aspect, means for selecting a machine learning module configuration from the set of machine learning module configurations based on the QoS type may be configured as or may comprise at least one of UE 104, processor 605, memory 360, beam prediction component 198, and/or selecting component 640.

At block 708, the method 700 includes performing one or more beam prediction procedures based on an output of a machine learning model indicated by the selected machine learning module configuration. For example, in an aspect, means for performing one or more beam prediction procedures based on an output of a machine learning model indicated by the selected machine learning module configuration may be configured as or may comprise at least one of UE 104, processor 605, memory 360, beam prediction component 198, and/or beam procedure performing component 625.

At block 710, the method 700 includes outputting, for transmission to the network entity, a report associated with the one or more beam prediction procedures. For example, in an aspect, means for outputting, for transmission to the network entity, a report associated with the one or more beam prediction procedures may be configured as or may comprise at least one of UE 104, processor 605, memory 360, beam prediction component 198, and/or transmitting component 630.

For example, the outputting at block 710 may include transmitting report via a wireless signal at an antenna or antenna array (e.g., antenna 352) as described in FIG. 3.

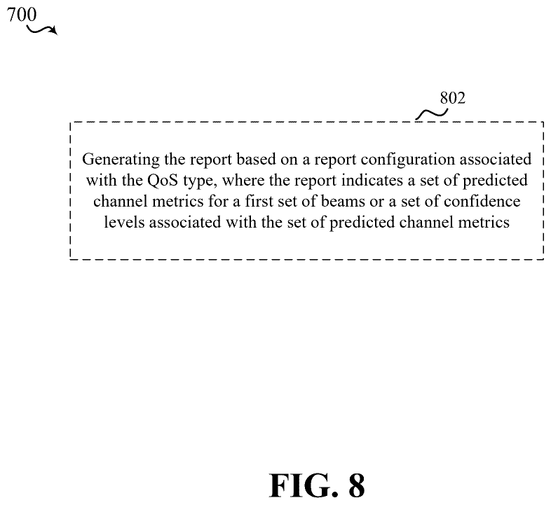

Referring to FIG. 8, in an alternative or additional aspect, at block 802, the method 700 may further include generating the report based on a report configuration associated with the QoS type, where the report indicates a set of predicted channel metrics for a first set of beams or a set of confidence levels associated with the set of predicted channel metrics. For example, in an aspect, means for generating the report based on a report configuration associated with the QoS type, where the report indicates a set of predicted channel metrics for a first set of beams or a set of confidence levels associated with the set of predicted channel metrics may be configured as or may comprise at least one of UE 104, processor 605, memory 360, beam prediction component 198, and/or generation component 660.

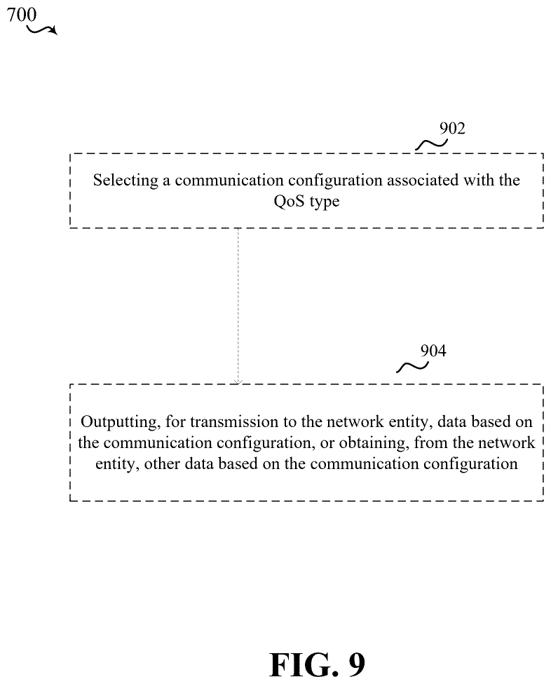

Referring to FIG. 9, in an alternative or additional aspect, at block 902, the method 700 may further include selecting a communication configuration associated with the QoS type. For example, in an aspect, means for selecting a communication configuration associated with the QoS type may be configured as or may comprise at least one of UE 104, processor 605, memory 360, beam prediction component 198, and/or selecting component 640.

In this optional aspect, at block 904, the method 700 may further include outputting, for transmission to the network entity, data based on the communication configuration, or obtaining, from the network entity, other data based on the communication configuration. For example, in an aspect, means for outputting, for transmission to the network entity, data via a subset of beams of the first set of beams based on the communication configuration, or obtaining, from the network entity, data via the subset of beams based on the communication configuration may be configured as or may comprise at least one of UE 104, processor 605, memory 360, beam prediction component 198, and/or transmitting component 630 and/or obtaining component 645.

For example, the outputting or the obtaining at block 804 may include outputting the data or obtaining the other data via a wireless signal at an antenna or antenna array (e.g., antenna 352) as described in FIG. 3.

In alternative or additional aspect, the communication configuration comprises a subset of beams of the first set of beams, and where the data is output for transmission via the subset of beams and the other data is obtained via the subset of beams.

In alternative or additional aspect, the report indicates a set of predicted channel metrics for a first set of beams or a set of confidence levels associated with the set of predicted channel metrics based on a report configuration associated with the QoS type.

In an alternative or additional aspect, the selecting at block 802 of communication configuration includes selecting the subset of beams.

In an alternative or additional aspect, the subset of beams include at least two beams and the data is output, for transmission to the network entity, via a diversity scheme involving the at least two beams.

In an alternative or additional aspect, a first beam of the at least two beams is associated with a highest predicted channel metric in the set of predicted channel metrics and a second beam of the at least two beams is associated with a second highest channel metric in the set of predicted channel metrics.

In an alternative or additional aspect, the subset of beams includes a beam with a highest predicted channel metric in the set of predicted channel metrics.

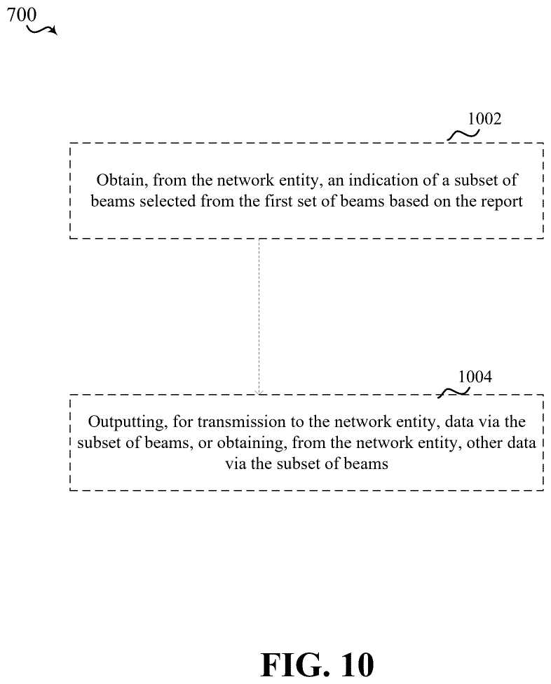

Referring to FIG. 10, in an alternative or additional aspect, at block 1002, the method 700 may further include obtaining, from the network entity, an indication of a subset of beams selected from the first set of beams based on the report. For example, in an aspect, means for obtaining, from the network entity, an indication of a subset of beams selected from the first set of beams based on the report may be configured as or may comprise at least one of UE 104, processor 605, memory 360, beam prediction component 198, and/or obtaining component 645.

For example, the obtaining at block 1002 may include obtaining or recieving the indication of a subset of beams selected from the first set of beams based on the report via wireless signal at an antenna or antenna array (e.g., antenna 352) as described in FIG. 3.

In this optional aspect, at block 1004, the method 700 may further include outputting, for transmission to the network entity, data via the subset of beams or obtaining, from the network entity, data via the subset of beams. For example, in an aspect, means for outputting, for transmission to the network entity, data via the subset of beams, or obtaining, from the network entity, data via the subset of beams may be configured as or may comprise at least one of UE 104, processor 605, memory 360, beam prediction component 198, and/or transmitting component 630, and/or obtaining component 645.

For example, the outputting at block 1004 may include outputting data via a wireless signal at an antenna or antenna array (e.g., antenna 352) as described in FIG. 3.

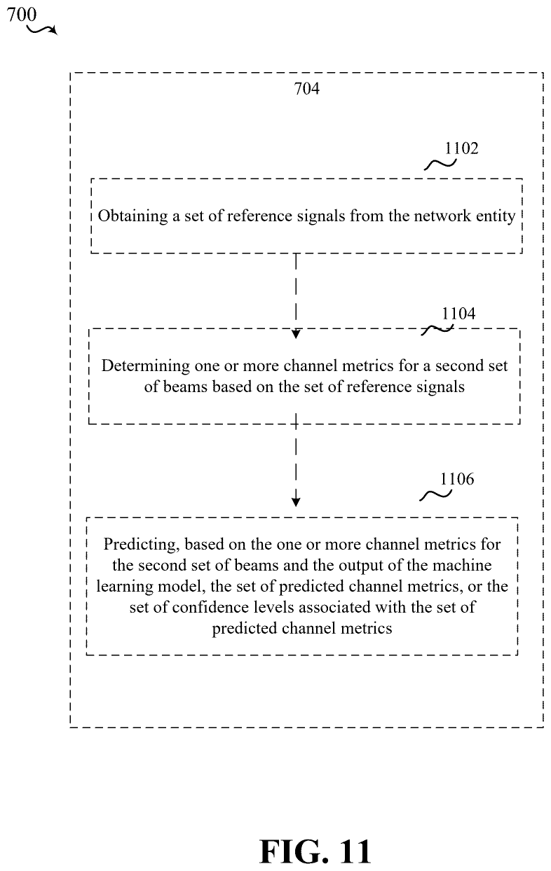

Referring to FIG. 11, in an alternative or additional aspect, at block 1102, the one or more beam prediction procedures at block 704 includes obtaining a set of reference signals from the network entity. For example, in an aspect, means for obtaining a set of reference signals from the network entity may be configured as or may comprise at least one of UE 104, processor 605, memory 360, beam prediction component 198, and/or obtaining component 645. For example, the obtaining at block 1102 may include obtaining or receiving the set of reference signals via wireless signal at an antenna or antenna array (e.g., antenna 352) as described in FIG. 3.

In an optional aspect, at block 1104, the one or more beam prediction procedures at block 704 includes determining one or more channel metrics for a second set of beams based on the set of reference signals. For example, in an aspect, means for determining one or more channel metrics of a second set of beams based on the set of reference signals may be configured as or may comprise at least one of UE 104, processor 605, memory 360, beam prediction component 198, and/or determination component 650.

In an optional aspect, at block 1106, the one or more beam prediction procedures at block 704 includes predicting based on the one or more channel metrics for the second set of beams and the output of the machine learning model, the set of predicted channel metrics, or the set of confidence levels associated with the set of predicted channel metric. For example, in an aspect, means for predicting based on the one or more channel metrics for the second set of beams and the output of the machine learning model, the set of predicted channel metrics, or the set of confidence levels associated with the set of predicted channel metric may be configured as or may comprise at least one of UE 104, processor 605, memory 360, beam prediction component 198, and/or prediction component 655.

In an alternative or additional aspect, a confidence level of the set of confidence levels indicates an accuracy of a predicted channel metric in the set of predicted channel metrics or a probability that a corresponding predicted channel metric of a beam in the first set of beams satisfies a threshold channel metric value at the a future time.

In an alternative or additional aspect, a predicted channel metric in the set of predicted channel metrics is associated with at least one of a reference signal received power (RSRP), a reference signal received quality (RSRQ), a sounding reference signal (SRS), a received signal strength indicator (RSSI), or a signal-to-noise and interference (SINR) ratio.

In an alternative or additional aspect, the report is output at a defined periodicity based on a report configuration associated with the QoS type.

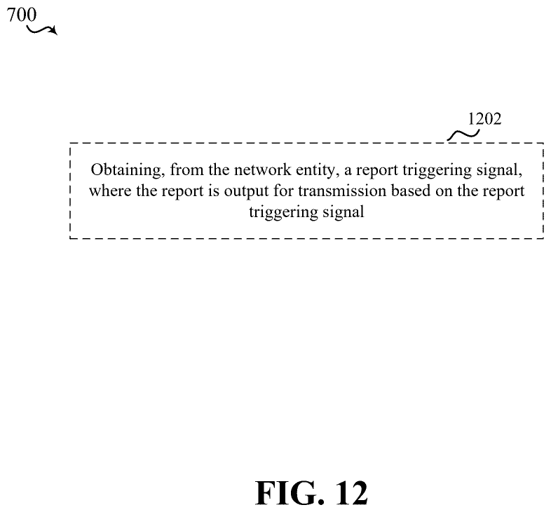

Referring to FIG. 12, in an alternative or additional aspect, at block 1202, the method 700 may further include obtaining, from the network entity, a report triggering signal, where the report is output for transmission based on the report triggering signal. For example, in an aspect, means for obtaining, from the network entity, a report triggering signal, where the report is output for transmission based on the report triggering signal may be configured as or may comprise at least one of UE 104, processor 605, memory 360, beam prediction component 198, and/or obtaining component 645.

For example, the obtaining at block 1202 may include obtaining or receiving a report triggering signal via wireless signal at an antenna or antenna array (e.g., antenna 352) as described in FIG. 3.

In an alternative or additional aspect, the report triggering signal may be received via an indication via DCI, MAC-CE, and the like from the network entity.

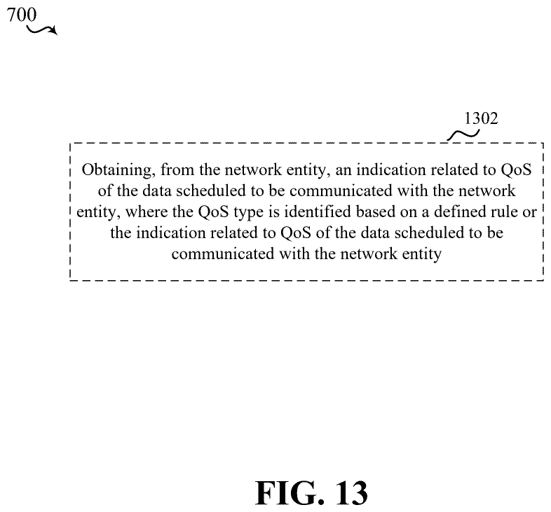

Referring to FIG. 13, in an alternative or additional aspect, at block 1302, the method 700 may further include obtaining, from the network entity, an indication related to QoS of the data scheduled to be communicated with the network entity, where the QoS type is identified based on a defined rule or the indication related to QoS of the data scheduled to be communicated with the network entity. For example, in an aspect, means for obtaining, from the network entity, an indication related to QoS of the data scheduled to be communicated with the network entity, the QoS type is identified based on a defined rule or the indication related to QoS of the data scheduled to be communicated with the network entity may be configured as or may comprise at least one of UE 104, processor 605, memory 360, beam prediction component 198, and/or obtaining component 645.

For example, the obtaining at block 1302 may include obtaining or receiving an indication related to QoS of the data scheduled to be communicated with the network entity via wireless signal at an antenna or antenna array (e.g., antenna 352) as described in FIG. 3.

In an alternative or additional aspect, the QoS type indicates a data priority or a traffic type of the data scheduled to be communicated with the network entity.

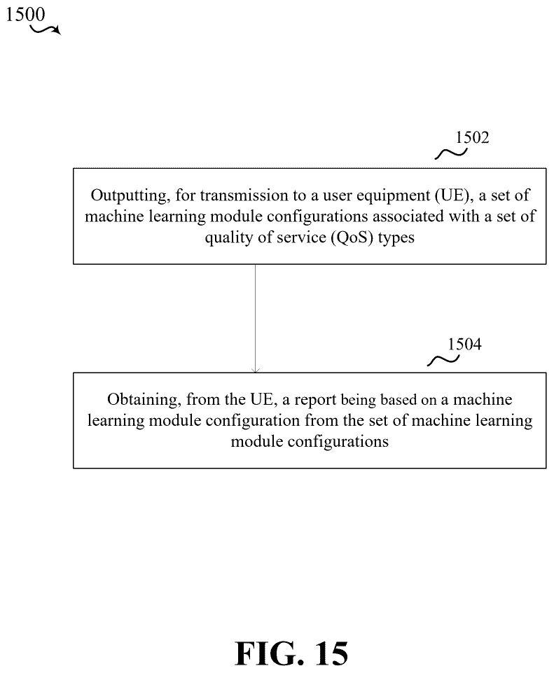

Referring to FIG. 14 and FIG. 15, in operation, network entity 102/180 may perform a method 1500 of wireless communication, by such as via execution of beam prediction component 199 by processor 1406 and/or memory 376 (FIG. 3). In this case, the processor 1406 may be the receive (rx) processor 370, the controller/processor 375, and/or the transmit (tx) processor 316 described above in FIG. 3.

At block 1502, the method 1500 includes outputting, for transmission to a user equipment (UE), a set of machine learning module configurations associated with a set of quality of service (QoS) types. For example, in an aspect, means for outputting, for transmission to a user equipment (UE), a set of machine learning module configurations associated with a set of quality of service (QoS) types may be configured as or may comprise at least one of network entity 102, processor 1406, memory 376, beam prediction component 199, and/or outputting component 1420.

For example, the outputting at block 1502 may include outputting, for transmission, or transmitting a set of machine learning module configurations associated with a set of QoS type via one or more wireless signals transmitted using an antenna or an antenna array (e.g., antenna 320).

At block 1504, the method 1500 includes obtaining, from the UE, a report being based on a machine learning module configuration from the set of machine learning module configurations. For example, in an aspect, means for obtaining, from the UE, a report being based on a machine learning module configuration from the set of machine learning module configurations may be configured as or may comprise at least one of network entity 102, processor 1406, memory 376, beam prediction component 199, and/or receiving component 1425.

For example, the obtaining at block 1504 may include obtaining or receiving the report via one or more wireless signals at an antenna or an antenna array (e.g., antenna 320) as described in FIG. 3, and processes the wireless signals as described in FIG. 3.

In an alternative or additional aspect, the report indicates a set of predicted channel metrics for a first set of beams or a set of confidence levels associated with the set of predicted channel metrics.

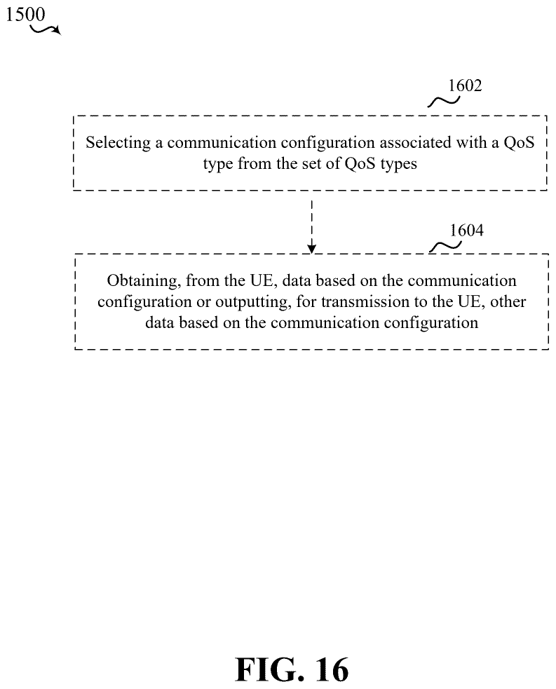

Referring to FIG. 16, in an alternative or additional aspect, at block 1602, the method 1500 may further include selecting a communication configuration associated with the QoS type from the set of QoS types. For example, in an aspect, means for selecting a communication configuration associated with the QoS type from the set of QoS types may be configured as or may comprise at least one of network entity 102, processor 1406, memory 376, beam prediction component 199, and/or selecting component 1430.

In this optional aspect, at block 1604, the method 1500 may further include obtaining, from the UE, data based on the communication configuration, or outputting, for transmission to the UE, other data based on the communication configuration. For example, in an aspect, means for obtaining, from the UE, data based on the communication configuration, or outputting, for transmission to the UE, other data based on the communication configuration may be configured as or may comprise at least one of network entity 102, processor 1406, memory 376, beam prediction component 199, and/or receiving component 1425.

For example, the obtaining or outputting at block 1604 may include obtaining or receiving data, or outputting or transmitting the other data via one or more wireless signals at an antenna or an antenna array (e.g., antenna 320) as described in FIG. 3, and processes the wireless signals as described in FIG. 3

In an alternative or additional aspect, the communication configuration comprises a subset of beams of a first set of beams indicated by the report, wherein the data is obtained via the subset of beams and the other data is output via the subset of beams.

In an alternative or additional aspect, the subset of beams include at least two beams and the data is obtained, from the UE, based on a diversity scheme applied involving the at least two beams.

In an alternative or additional aspect, the subset of beams includes a beam with the highest predicted channel metric in the set of predicted channel metrics based on the QoS type indicating normal priority.

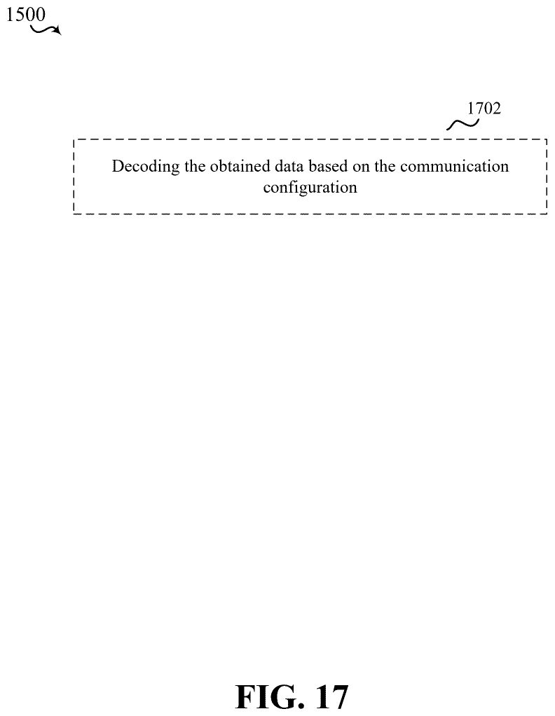

Referring to FIG. 17, in an alternative or additional aspect, at block 1702, the method 1500 may further include decoding the obtained data based on the communication configuration. For example, in an aspect, means for decoding the obtained data based on the communication configuration may be configured as or may comprise at least one of network entity 102, processor 1406, memory 376, beam prediction component 199, and/or decoding component 1435.

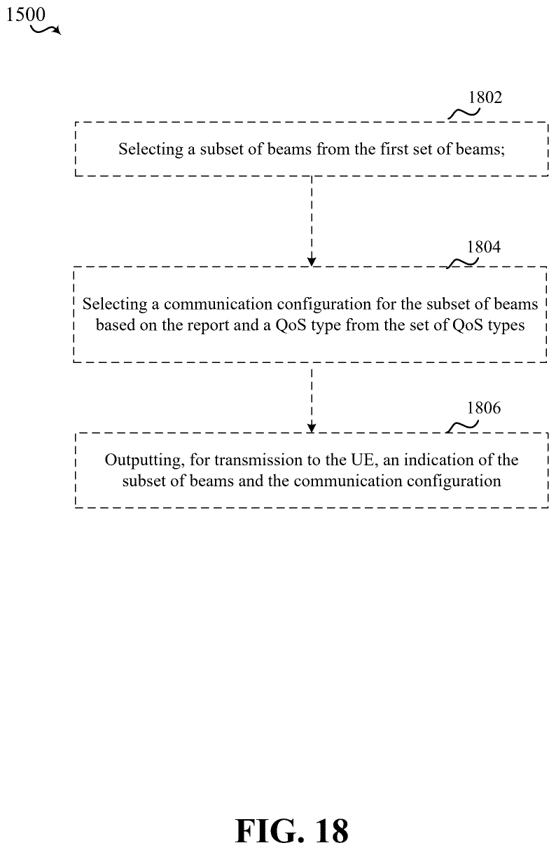

Referring to FIG. 18, in an alternative or additional aspect, at block 1802, the method 1500 may further include selecting a subset of beams from the first set of beams. For example, in an aspect, means for selecting a subset of beams from the first set of beams may be configured as or may comprise at least one of network entity 102, processor 1406, memory 376, beam prediction component 199, and/or selecting component 1430.

In this optional aspect, at block 1804, the method 1500 may include selecting a communication configuration for the subset of beams based on the report and a QoS type from the set of QoS types. For example, in an aspect, means for selecting a communication configuration for the subset of beams based on the report and a QoS type from the set of QoS types may be configured as or may comprise at least one of network entity 102, processor 1406, memory 376, beam prediction component 199, and/or selecting component 1430.

In this optional aspect, at block 1806, the method 1500 may further include outputting, for transmission to the UE, an indication of the subset of beams and the communication configuration. For example, in an aspect, means for outputting an indication of the subset of beams and the communication configuration may be configured as or may comprise at least one of network entity 102, processor 1406, memory 376, beam prediction component 199, and/or outputting component 1420.

For example, the outputting at block 1806 may include outputting or transmitting the indication of the subset of beams and the communication configuration via one or more wireless signals transmitted using an antenna or an antenna array (e.g., antenna 320).

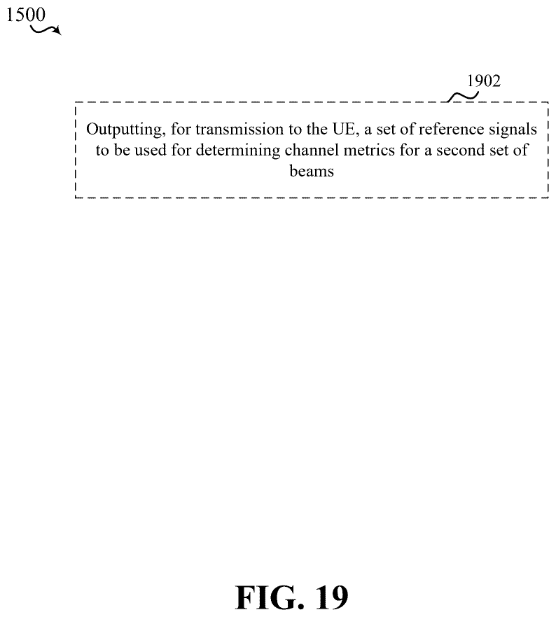

Referring to FIG. 19, in an alternative or additional aspect, at block 1902, the method 1500 may further include outputting, to the UE, a set of reference signals for determination of channel metrics for a second set of beams. For example, in an aspect, means for outputting, to the UE, a set of reference signals for determination of channel metrics for a second set of beams may be configured as or may comprise at least one of network entity 102, processor 1406, memory 376, beam prediction component 199, and/or outputting component 1420.

For example, the outputting at block 1902 may include outputting or transmitting the set of reference signals for determination of channel metrics for a second set of beams via one or more wireless signals transmitted using an antenna or an antenna array (e.g., antenna 320).

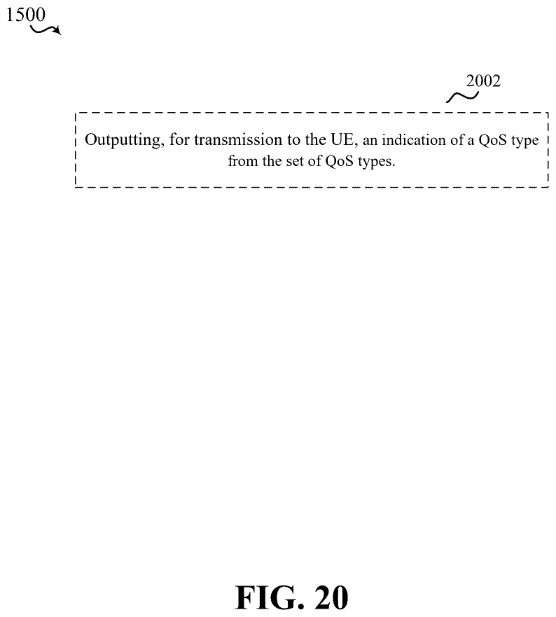

Referring to FIG. 20, in an alternative or additional aspect, at block 2002, the method 1500 includes outputting, for transmission to the UE, an indication of a QoS type from the QoS types. For example, in an aspect, means for outputting, for transmission to the UE, an indication of a QoS type from the set of QoS types may be configured as or may comprise at least one of network entity 102, processor 1406, memory 376, beam prediction component 199, and/or transmitting component 1420.

For example, the outputting at block 2002 may include outputting or transmitting indication of a QoS type via one or more wireless signals transmitted using an antenna or an antenna array (e.g., antenna 320).

In an alternative or additional aspect, the QoS type indicates a data priority or a traffic type of data scheduled to be communicated with the UE.

In an alternative or additional aspect, the report is obtained at a defined periodicity based on a report configuration associated with the QoS type.

In an alternative or additional aspect, the QoS type indicates a physical layer (PHY) priority of the report.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is a method of wireless communication at a user equipment, comprising: obtaining, from a network entity, a set of machine learning module configurations associated with a set of quality of service (QoS) types; identifying a QoS type, from the set of QoS types, for data scheduled to be communicated with the network entity; selecting a machine learning module configuration from the set of machine learning module configurations based on the QoS type; performing one or more beam prediction procedures based on an output of a machine learning model indicated by the selected machine learning module configuration; and outputting, for transmission to the network entity, a report associated with the one or more beam prediction procedures.

Example 2 is the method of example 1, further comprising: generating the report based on a report configuration associated with the QoS type, wherein the report indicates a set of predicted channel metrics for a first set of beams or a set of confidence levels associated with the set of predicted channel metrics.

Example 3 is the method of example 2, further comprising: selecting a communication configuration associated with the QoS type; and outputting, for transmission to the network entity, data based on the communication configuration, or obtaining, from the network entity, other data based on the communication configuration.

Example 4 is the method of example 3, wherein the communication configuration comprises: a subset of beams of the first set of beams, wherein the data is output for transmission via the subset of beams and the other data is obtained via the subset of beams.

Example 5 is the method of example 4, wherein the subset of beams includes at least two beams and the data is output, for transmission to the network entity, via a diversity scheme involving the at least two beams.

Example 6 is the method of example 5, wherein a first beam of the at least two beams is associated with a highest predicted channel metric in the set of predicted channel metrics and a second beam of the at least two beams is associated with a second highest channel metric in the set of predicted channel metrics.

Example 7 is the method of example 4, wherein the subset of beams includes a beam with a highest predicted channel metric in the set of predicted channel metrics.

Example 8 is the method of example 2, further comprising: obtaining, from the network entity, an indication of a subset of beams selected from the first set of beams based on the report; and outputting, for transmission to the network entity, other data via the subset of beams, or obtaining, from the network entity, data via the subset of beams.

Example 9 is the method of example 2, wherein the one or more beam prediction procedures comprises: obtaining a set of reference signals from the network entity; determining one or more channel metrics for a second set of beams based on the set of reference signals; and predicting, based on the one or more channel metrics for the second set of beams and the output of the machine learning model, the set of predicted channel metrics, or the set of confidence levels associated with the set of predicted channel metrics.

Example 10 is the method of example 2, wherein a confidence level of the set of confidence levels indicates an accuracy of a predicted channel metric in the set of predicted channel metrics or a probability that a corresponding predicted channel metric of a beam in the first set of beams satisfies a threshold channel metric value at a future time.

Example 11 is the method of example 2, wherein a predicted channel metric in the set of predicted channel metrics is associated with at least one of a reference signal received power (RSRP), a reference signal received quality (RSRQ), a sounding reference signal (SRS), a received signal strength indicator (RSSI), or a signal-to-noise and interference (SINR) ratio.

Example 12 is the method of any of examples 1-11, wherein the report is output at a defined periodicity based on a report configuration associated with the QoS type.

Example 13 is the method of any of examples 1-12, further comprising: obtaining, from the network entity, a report triggering signal, wherein the report is output, for transmission, based on the report triggering signal.

Example, 14 is the method of any of examples 1-13, further comprising: obtaining, from the network entity, an indication related to QoS of the data scheduled to be communicated with the network entity, wherein the QoS type is identified based on a defined rule or the indication related to QoS of the data scheduled to be communicated with the network entity.

Example 15, is the method of any of examples 1-14, wherein the QoS type indicates a data priority or a traffic type of the data scheduled to be communicated with the network entity.

Example 16 is a method of wireless communication at a network entity, comprising: output, for transmission to a user equipment (UE), a set of machine learning module configurations associated with a set of quality of service (QoS) types; and obtaining, from the UE, a report being based on a machine learning module configuration from the set of machine learning module configurations.

Example 17 is the method of example 16, wherein the report indicates a set of predicted channel metrics for a first set of beams or a set of confidence levels associated with the set of predicted channel metrics.

Example 18 is the method of any of examples 16-17, further comprising: selecting a communication configuration associated with a QoS type from the set of QoS types; obtaining, from the UE, data based on the communication configuration, or output, for transmission to the UE, other data based on the communication configuration.

Example 19 is the method of example 18, wherein the communication configuration comprises a subset of beams of a first set of beams indicated by the report, wherein the data is obtained via the subset of beams or the other data is output via the subset of beams.

Example 20 is the method of example 19, wherein the subset of beams includes at least two beams and the data is obtained, from the UE, based on a diversity scheme involving the at least two beams.

Example 21 is the method of example 19, wherein the subset of beams includes a beam with a highest predicted channel metric in the set of predicted channel metrics based on the QoS type indicating normal priority.

Example 22, is the method of example 18, further comprising: decoding the data based on the communication configuration.

Example 23 is the method of example 17, further comprising: selecting a subset of beams from the first set of beams; selecting a communication configuration for the subset of beams based on the report and a QoS type from the set of QoS types; and outputting, for transmission, an indication of the subset of beams and the communication configuration.

Example 24 is the method of example 17, further comprising: outputting, for transmission to the UE, a set of reference signals to be used for determining channel metrics for a second set of beams.

Example 25 is the method of any of examples 16-24, further comprising: outputting, for transmission to the UE, an indication of a QoS type from the set of QoS types.

Example 26 is the method of example 25, wherein the QoS type indicates a data priority or a traffic type of data scheduled to be communicated with the UE.

Example 27 is the method of example 25, wherein the report is obtained at a defined periodicity based on a report configuration associated with the QoS type.

Example 28 is the method of example 18, wherein the QoS type indicates a physical layer (PHY) priority of the report.

Example 29 is a user equipment (UE) comprising: a transceiver; a memory comprising instructions; and one or more processors configured to cause the UE to perform a method in accordance with any one of examples 1-15, wherein the transceiver is configured to: receive the set of machine learning module configurations; and transmit the report.

Example 30 is a network entity comprising: a transceiver; a memory comprising instructions; and one or more processors configured to cause the network entity to perform a method in accordance with any one of examples 16-28, wherein the transceiver is configured to: transmit the set of machine learning module configurations; and receive the report.

Example 31 is an apparatus for wireless communications, comprising means for performing a method in accordance with any one of examples 1-15.

Example 32 is an apparatus for wireless communications, comprising means for performing a method in accordance with any one of examples 16-28.

Example 33 is a non-transitory computer-readable medium comprising instructions that, when executed by an apparatus, causes the apparatus to perform a method in accordance with any one of examples 1-15.

Example 34 is a non-transitory computer-readable medium comprising instructions that, when executed by an apparatus, cause the apparatus to perform a method in accordance with any one of examples 16-28.

Example 35 is an apparatus for wireless communications, comprising: a memory comprising instructions; and one or more processors configured to execute the instructions to cause the apparatus to perform a method in accordance with any one of examples 1-15.

Example 36 is apparatus for wireless communications, comprising: a memory comprising instructions; and one or more processors configured to execute the instructions to cause the apparatus to perform a method in accordance with any one of examples 16-28.

What is claimed is:

1. An apparatus configured for wireless communication, comprising:
a memory comprising instructions; and
one or more processors configured to execute the instructions and cause the apparatus to:
obtain, from a network entity, a set of machine learning module configurations associated with a set of quality of service (QoS) types;
identify a QoS type, from the set of QoS types, for data scheduled to be communicated with the network entity;
select a machine learning module configuration from the set of machine learning module configurations based on the QoS type;
perform one or more beam prediction procedures based on an output of a machine learning model indicated by the selected machine learning module configuration; and
output, for transmission to the network entity, a report associated with the one or more beam prediction procedures.

2. The apparatus of claim 1, wherein the one or more processors are further configured to cause the apparatus to:
generate the report based on a report configuration associated with the QoS type, wherein the report indicates a set of predicted channel metrics for a first set of beams or a set of confidence levels associated with the set of predicted channel metrics.

3. The apparatus of claim 2, wherein the one or more processors are further configured to cause the apparatus to:
select a communication configuration associated with the QoS type; and
output, for transmission to the network entity, data based on the communication configuration, or
obtain, from the network entity, other data based on the communication configuration.

4. The apparatus of claim 3, wherein communication configuration comprises:
a subset of beams of the first set of beams, wherein the data is output for transmission via the subset of beams and the other data is obtained via the subset of beams.

5. The apparatus of claim 4, wherein the subset of beams includes at least two beams and the data is output, for transmission to the network entity, via a diversity scheme involving the at least two beams.

6. The apparatus of claim 5, wherein a first beam of the at least two beams is associated with a highest predicted channel metric in the set of predicted channel metrics and a second beam of the at least two beams is associated with a second highest channel metric in the set of predicted channel metrics.

7. The apparatus of claim 4, wherein the subset of beams includes a beam with a highest predicted channel metric in the set of predicted channel metrics.

8. The apparatus of claim 2, wherein the one or more processors are further configured to cause the apparatus to:
obtain, from the network entity, an indication of a subset of beams selected from the first set of beams based on the report; and
output, for transmission to the network entity, data via the subset of beams, or
obtain, from the network entity, other data via the subset of beams.

9. The apparatus of claim 2, wherein the one or more beam prediction procedures comprise:
obtaining a set of reference signals from the network entity;
determining one or more channel metrics for a second set of beams based on the set of reference signals; and
predicting, based on the one or more channel metrics for the second set of beams and the output of the machine learning model, the set of predicted channel metrics or the set of confidence levels associated with the set of predicted channel metrics.

10. The apparatus of claim 2, wherein a confidence level of the set of confidence levels indicates an accuracy of a predicted channel metric in the set of predicted channel metrics or a probability that a corresponding predicted channel metric of a beam in the first set of beams satisfies a threshold channel metric value at a future time.

11. The apparatus of claim 2, wherein a predicted channel metric in the set of predicted channel metrics is associated with at least one of a reference signal received power (RSRP), a reference signal received quality (RSRQ), a sounding reference signal (SRS), a received signal strength indicator (RSSI), or a signal-to-noise and interference (SINR) ratio.

12. The apparatus of claim 1, wherein the report is output at a defined periodicity based on a report configuration associated with the QoS type.

13. The apparatus of claim 1, wherein the one or more processors are further configured to cause the apparatus to:
obtain, from the network entity, a report triggering signal, wherein the report is output for transmission based on the report triggering signal.

14. The apparatus of claim 1, wherein the one or more processors are further configured to cause the apparatus to: :
obtain, from the network entity, an indication related to QoS of the data scheduled to be communicated with the network entity, wherein the QoS type is identified based on a defined rule or the indication related to QoS of the data scheduled to be communicated with the network entity.

15. The apparatus of claim 1, wherein the QoS type indicates a data priority or a traffic type of the data scheduled to be communicated with the network entity.

16. A user equipment (UE), comprising:
a transceiver;
a memory comprising instructions; and
one or more processors configured to execute the instructions and cause the UE to:
receive, via the transceiver and from a network entity, a set of machine learning module configurations associated with a set of quality of service (QoS) types;
identify a QoS type, from the set of QoS types, for data scheduled to be communicated with a network entity;
select a machine learning module configuration from the set of machine learning module configurations based on the QoS type;
perform one or more beam prediction procedures based on an output of a machine learning model indicated by the selected machine learning module configuration; and
transmit, via the transceiver and to the network entity, a report associated with the one or more beam prediction procedures.

17. An apparatus configured for wireless communication, comprising:
a memory comprising instructions; and
one or more processors configured to execute the instructions and cause the apparatus to:
output, for transmission to a user equipment (UE), a set of machine learning module configurations associated with a set of quality of service (QoS) types; and
obtain, from the UE, a report being based on a machine learning module configuration from the set of machine learning module configurations.

18. The apparatus of claim 17, wherein the report indicates a set of predicted channel metrics for a first set of beams or a set of confidence levels associated with the set of predicted channel metrics.

19. The apparatus of claim 17, wherein the one or more processors are further configured to cause the apparatus to:
select a communication configuration associated with a QoS type from the set of QoS types;
obtain, from the UE, data based on the communication configuration, or
output, for transmission to the UE, other data based on the communication configuration.

20. The apparatus of claim 19, wherein the communication configuration comprises a subset of beams of a first set of beams indicated by the report, wherein the data is obtained via the subset of beams or the other data is output via the subset of beams.

21. The apparatus of claim 20, wherein the subset of beams includes at least two beams and the data is obtained, from the UE, based on a diversity scheme involving the at least two beams.

22. The apparatus of claim 20, wherein the subset of beams includes a beam with a highest predicted channel metric in the set of predicted channel metrics based on the QoS type indicating normal priority.

23. The apparatus of claim 19, wherein the one or more processors are further configured to cause the apparatus to:
decode the data based on the communication configuration.

24. The apparatus of claim 18, wherein the one or more processors are further configured to cause the apparatus to:
select a subset of beams from the first set of beams;
select a communication configuration for the subset of beams based on the report and a QoS type from the set of QoS types; and
output, for transmission to the UE, an indication of the subset of beams and the communication configuration.

25. The apparatus of claim 18, wherein the one or more processors are further configured to cause the apparatus to:
output, for transmission to the UE, a set of reference signals to be used for determining channel metrics for a second set of beams.

26. The apparatus of claim 17, wherein the one or more processors are further configured to cause the apparatus to:
output, for transmission to the UE, an indication of a QoS type from the set of QoS types.

27. The apparatus of claim 26, wherein the QoS type indicates a data priority or a traffic type of data scheduled to be communicated with the UE.

28. The apparatus of claim 26, wherein the report is obtained at a defined periodicity based on a report configuration associated with the QoS type.

29. The apparatus of claim 19, wherein the QoS type indicates a physical layer (PHY) priority of the report.

30. The apparatus of claim 17, further comprising a transceiver configured to:
transmit the set of machine learning module configurations; and
receive the report, wherein the apparatus is configured as a network entity.
